(19) United States
(12) Patent Application Publication
(10) Pub. No.: US 2019/0138930 A1
(43) Pub. Date: May 9, 2019

(54) SYSTEMS AND METHODS FOR REAL-TIME DATA PROCESSING ANALYTICS ENGINE WITH ARTIFICIAL INTELLIGENCE FOR TARGET INFORMATION PROTECTION

(71) Applicant: ADNOMUS, INC., San Jose, CA (US)

(72) Inventor: Christos Margiolas, San Jose (CA)

(21) Appl. No.: 15/994,830

(22) Filed: May 31, 2018

Related U.S. Application Data
(60) Provisional application No. 62/513,159, filed on May 31, 2017.

(51) Int. Cl. G06N 20/00; G06Q 30/02

(52) U.S. Cl. CPC G06N 20/00; G06Q 30/0251

(57) ABSTRACT

Example implementations are directed to systems and methods to process content employing a model for characterizing targeted content where the model is trained to flag indefinable user information; analyze the content to develop a sensitive data index based on content that is flagged by the model; and apply machine learning to generate characterization data and contextual data for the information associated with one or more users based on the sensitive data index, where the machine learning utilizes content adjacent to the information associated with one or more users and the sensitive data index in a neural network to output substitute terms.

This application claims priority under 35 USC 119 based on U.S. Provisional Patent Application No. 62/513,159, filed on May 31, 2017, the contents of which is incorporated herein in its entirety by reference.

### 1. TECHNICAL FIELD

The embodiments described herein are related to data analytics and more specifically to target information protection using artificial intelligence.

### 2. BACKGROUND

People spend more time on-line interacting with social media, online shopping, messaging, sharing content, etc. that results in more user generated content than publisher developed content. Further, a large portion of online content is private and not accessible by existing content selection/analysis services. With the growing volume of user generated content, publisher's conventional approaches to handling and processing content are becoming ineffective.

Publishers traditionally integrate with different exchange platforms that each have specific requirements and are generally not compatible with other exchange platforms. Thus, diversification of exchange platforms increases publisher overhead through on-boarding and additional data handling processing costs.

Further, typical approaches to processing user generated content are inadequate for changing legal standards for privacy compliance. Personally identifiable information or sensitive personal information generally refers to information that can be used with other information to identify, contact, or locate a single person, or to identify an individual in context. Some countries impose privacy protection laws that require special processing and handling of personally identifiable information that can carry civil, monetary, and criminal penalties. For example, since 1996 the United States has had the Health Insurance Portability and Accountability Act (HIPAA) to addresses the use and disclosure of individuals' protected health information, and in 2018 the European Union will have the General Data Protection Regulation to address processing of personal data and contact information. Further, corporate governance and industry groups are increasingly adopting voluntary compliance standards for maintaining and protecting personally identifiable information.

### BRIEF DESCRIPTION OF THE DRAWINGS

Features, aspects, and embodiments are described in conjunction with the attached drawings, in which:

FIG. 1 illustrates an overview of a system in accordance with an example implementation.

FIG. 2 illustrates an example content engine with a privacy and security module in accordance with an example implementation.

FIG. 3 illustrates a target protection flow diagram of an example sequence in accordance with an example implementation.

FIG. 4 illustrates how the analytics technology converts data of any type to plain text. The analytics technology converts every kind of content to text and follows a unified analysis approach after that.

FIG. 5 illustrates an example privacy and analytics flow diagram in accordance with an example implementation.

FIG. 6 illustrates an example processing diagram for an example analytics process in accordance with an example implementation. FIG. 6 describes how the analytics technology receives as input the given content along with additional information.

FIG. 7 illustrates an example data representation diagram for an analytics engine in accordance with an example implementation. The data representation of FIG. 7 provides the required analysis and model data in low-latency and low-overhead manner.

FIG. 8 depicts an example implementation for converting high level model descriptions to highly optimized code that delivers high performance on multi-core and heterogeneous platforms consisting of diverse processor, memory and networking technologies.

FIG. 9 illustrates an example server computing environment with an example computer device suitable for use in example implementations.

FIG. 10 illustrates an example networking environment with example computer devices suitable for use in example implementations.

FIG. 11 illustrates a block diagram of an example computing device or system that may be used in connection with various example implementations described herein.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

Example implementations are directed to systems and methods to process content employing a model for characterizing targeted content where the model is trained to flag indefinable user information; analyze the content to develop a sensitive data index based on content that is flagged by the model; and apply machine learning to generate characterization data and contextual data for the information associated with one or more users based on the sensitive data index, where the machine learning utilizes content adjacent to the information associated with one or more users and the sensitive data index in a neural network to output substitute terms.

Multiple application areas in computing systems and Information Technology services depend on real-time analysis of content provided either by users and/or third parties. The content is typically received as text, speech, image and video forms. An aspect of the present discloser describes real-time analysis on the contextual and sentimental reasoning of given content. An example aspect of the disclosure described herein includes real-time requirement and multi-origin factors that create large resource savings and new functionality for users. As described herein, the methods and systems receive input from multiple source origins and are backwards-compatible across existing legacy platforms to create protocols for easy and efficient platform integration and cross platform harmonization.

An example implementation includes characterizing and classifying the intentions and/or interests of the creator and/or receiver of the content. The analysis results can be used for the support of a recommendation system by delivering terms that precisely describe the intentions and interests of the content creator/viewer. The term “real-time analysis” denotes the requirement of performing the content analysis and recommendation in a short time window, which is typically at most few milliseconds.

Furthermore, present discloser includes modules to guarantee user and content privacy. Supplemental content is targeted with a precise understanding of content without jeopardizing content and/or user privacy. According to an embodiment of the present discloser, a targeted content system can be integrated with products such as online advertising, smart agents and service recommendation systems. For example, the targeted content system can integrate with the existing advertising ecosystem where programmatic ad exchange takes place.

Example implementation includes a specialized auction technology and industrial practice where advertisers bid on-the-fly for placing their adverts in third-party websites and applications. This procedure takes place in few hundred milliseconds and it is typically driven by simple heuristics and various forms of off-line analytics. The targeted content system uses on-line analysis for content-aware supplemental content targeting and in order to protect against prohibitive overheads and latencies to perform the analytics in less than 1 ms.

In an example implementation, the targeted content engine receives content associated with a user's digital activities in a source form; applies a conversion framework based on the source form that outputs the content as data in a development form; determines contextual terms of the data in the development form; gathers environmental information associated with the content and user's digital activities; generates a primary indexer and secondary indexer to map a set of individual identifiers to the data; applies machine learning to generate characterization data and contextual data based on the environmental information, wherein the machine learning; utilizes the primary indexer and secondary indexer in a neural network to output a live model; updates the live model with feedback; processes the data with the live model and feedback to preform real-time analysis about the data; performs data placement to package the analysis with the content in source form to a publisher based on a scheduling policy.

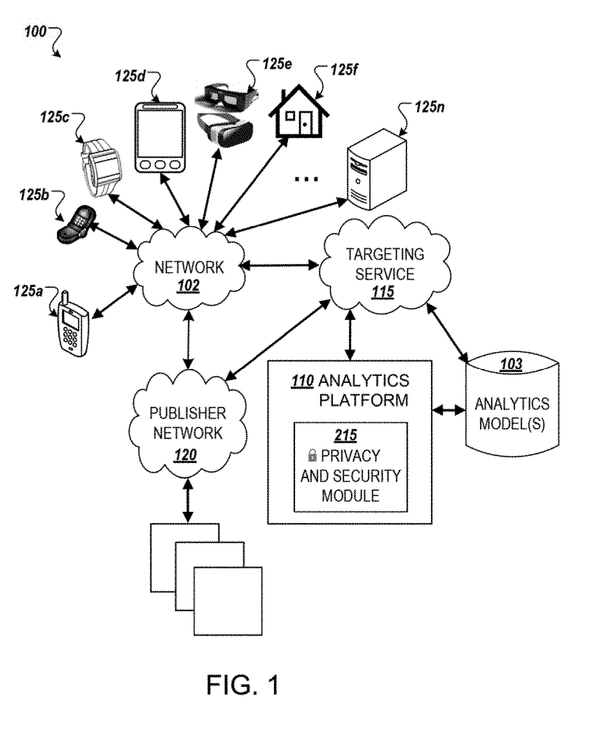

FIG. 1 illustrates an overview of a system 100 in accordance with an example implementation. The system 100 includes an analytics platform 110 configured to provide targeted content services 115 to one or more publisher networks 120.

A publisher network 120 can communicate with one or more client devices 125a-125n to provide content and/or supplemental. In accordance with embodiments described herein, the analytics platform 110 can identify supplemental content for the publisher network 120 to deliver to client devices 125a-125n.

The analytics platform 110 may be implemented in the form of software (e.g., instructions on a non-transitory computer readable medium) running on one or more processing devices, such as the one or more client, as a cloud service 115, remotely via a network, as part of the publisher network(s) 120 or other configuration known to one of ordinary skill in the art.

The terms “computer”, “computer platform”, processing device, and client device are intended to include any data processing device, such as a desktop computer, a laptop computer, a tablet computer, a mainframe computer, a server, a handheld device, a digital signal processor (DSP), an embedded processor, or any other device able to process data. The computer/computer platform is configured to include one or more microprocessors communicatively connected to one or more non-transitory computer-readable media and one or more networks.

The analytics platform 110 directly or indirectly includes memory such as Analytics Model 103 (e.g., RAM, ROM, and/or internal storage, magnetic, optical, solid state storage, and/or organic), any of which can be coupled on a communication mechanism (or bus) for communicating information.

In an example implementation, the analytics platform 110 can be host a targeting service 115 as a cloud service and communicatively connected via a network to receive user generated content.

The term “communicatively connected” is intended to include any type of connection, wired or wireless, in which data may be communicated. The term “communicatively connected” is intended to include, but not limited to, a connection between devices and/or programs within a single computer or between devices and/or separate computers over the network 102. The term “network” is intended to include, but not limited to, packet-switched networks such as local area network (LAN), wide area network (WAN), TCP/IP, (the Internet), and can use various means of transmission, such as, but not limited to, WiFi®, Bluetooth®, Zigbee®, Internet Protocol version 6 over Low-power Wireless Area Networks (6LowPAN), power line communication (PLC), Ethernet (e.g., 10 Megabyte (Mb), 100 Mb and/or 1 Gigabyte (Gb) Ethernet) or other communication protocols.

User generated content can be data associated with a user received from a client device (e.g., client device 125a-125n), remote servers (e.g., server 125X). third-party databases, or other configuration known to one of ordinary skill in the art. Data associated with the user or a client device of the user, may come from different types of client devices 125a-125n. Client devices 125a-125n can include, for example, handheld digital devices 125a, mobile phones 125b, wearable technology 125c (e.g., fitness trackers, location sensors, GPS units, Bluetooth® beacons, etc.), mobile computing devices 125d (e.g., laptops, tablets, etc.), virtual and augmented reality devices 125e, computing devices 125n (e.g., desktops, mainframes, network equipment, etc.), location based systems 125f (e.g., control systems, building environment control devices, security systems, corporate infrastructure, smart environments, etc.), as well as cloud services 125g (e.g., remotely available proprietary or public computing resources).

Publisher network 120 can include client data gathering services with functionality, for example, to collect, track, transmit, and/or store user generated content, manage communications with external services, and so forth. For example, the publisher network 120 can acquire client data based on a client device identifier, user account, IP address, a third-party gathering tracking service, etc. In example implementations, the analytics platform 110 receives user identifying information from multiple client device 125a-125n requesting content, tracks the multiple client device 125a-125n based on the identifying information, gathers user generated content based in real-time or near real-time.

Client devices 125a-125n may also collect information from one or more other client device 125a-125n and provide the collected information, directly or indirectly, to the analytics platform 110. For example, client devices 125a-125n can be communicatively connected to the other client device using WiFi®, Bluetooth®, Zigbee®, Internet Protocol version 6 over Low-power Wireless Area Networks (6LowPAN), power line communication (PLC), Ethernet (e.g., 10 Megabyte (Mb), 100 Mb and/or 1 Gigabyte (Gb) Ethernet) or other communication protocols.

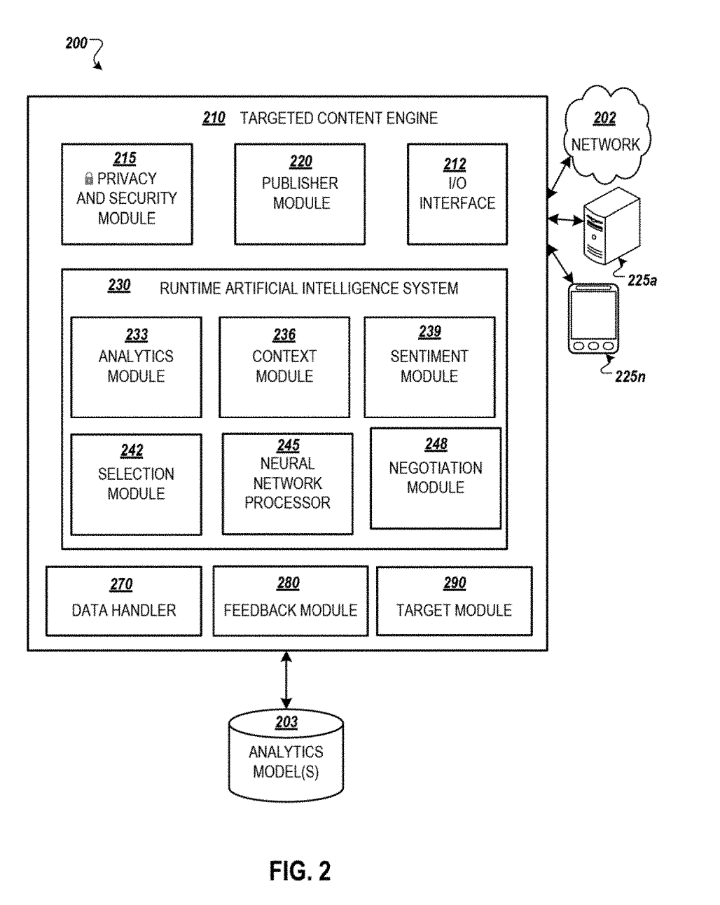

FIG. 2 illustrates an example system 200 including a targeted content engine 210 in accordance with an example implementation. The targeted content engine 210 includes one or more I/O interfaces 212, a privacy and security module 215, a publisher module 220, a runtime artificial intelligence system 230,

In an example implementation, the I/O interface 212 includes one or more communication interfaces communicatively connected with different types of client devices 225a-225n (e.g., client devices 125a-125n of FIG. 1) directly or via a network 202 in order to receive information associated with user generated content. The I/O interface 212 can receive data from different types of client devices 225 (e.g., client devices 125a-125n) or client services and communicate with content publishers via the publisher module 220. In some example implementations, the analytics process may operate directly on the client device 125a-125n.

The targeted content engine 210 receives, via the I/O interface 212, information such user generated content, environmental data, etc., and analyzes the information, via runtime artificial intelligence system 230, to generate. According to an embodiment, the runtime artificial intelligence system 230 can include an analytics module 233, a context module 236, a sentiment module 239, a selection module 242, a neural network processor 245, a negotiation module 248, etc.

Privacy and security module 215 is used to characterize any arbitrary content and generate characterization and recommendation terms for each term without exposing any personal and/or sensitive information. For example, the privacy and security module 215 analyzes the content to generate descriptive/recommendation substitute terms for a phrase.

For example, in response to receiving content with the phrase: “John Smith wants a new sports car in San Francisco,” the privacy and security module 215 of the analytics engine generates substitute terms that describe intention and interest. The processing by the analytics engine and the substitute terms do not expose any sensitive information about the ID of the person in the phrase (“John Smith”). For example, the process transforms the phrase “John Smith wants a new sport car in San Francisco” to “UND_ID0 UND_ID1 wants a new sport car in San Francisco”.

Sensitive information is not stored and not propagated to third parties. The privacy and security module 215 seamlessly ignores and drop any sensitive data while ensuring that the content can be successfully analyzed to process for targeted content services.

In an example implementation, the privacy and security module 215 generates terms out of a predefined vocabulary which do not represent the identifiable information (e.g., names, addresses, etc.). In an example implementation, the privacy and security module 215 analytics may preserve anonymous profiles about users, groups of users, social media or media trends and application specific information. For example, the privacy and security module 215 can preserve statistical information.

The privacy and security module 215 defines a vocabulary which includes terms that do not violate privacy or disclose personal information. The privacy and security module 215 can then traverse training data to remove any entries which are not included in the vocabulary. It is noted that the privacy and security module 215 does not simply remove the entries but rather replaces sensitive data with special placeholder IDs in order to maintain the syntax and semantical characteristics of text or phrases. For example, the phrase “John Smith wants a new sport car in San Francisco” is transformed to “UND_ID0 UND_ID1 wants a new sport car in San Francisco”.

The models may depend on the mapping of each content term that is processed to a data representation (e.g., an embedding, a neural network, etc.). For the special placeholders, when the representation is not natively available, the privacy and security module 215 construct a substitute term based on the data representations of the adjacent terms.

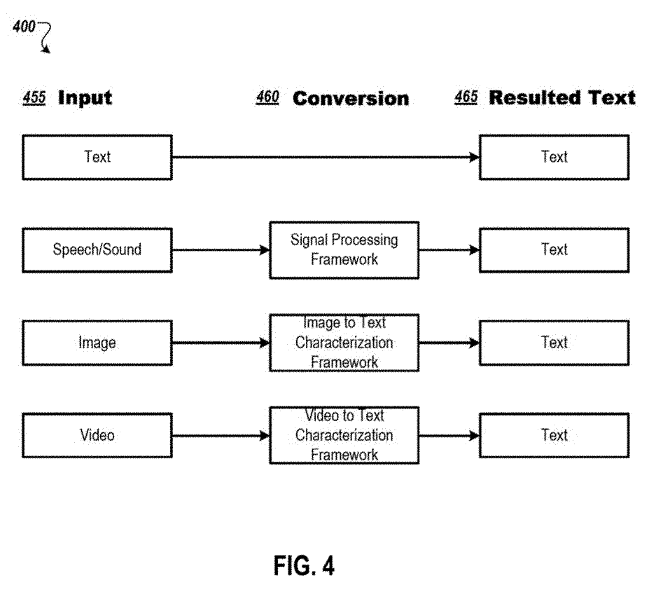

The targeted content engine 210 can also include a data handler module 270, a feedback module 280, and target module 290. The targeted content engine 210 is coupled to one or more Analytics Model repositories 203 for storing data (e.g., information, content, models, feedback, anonymized data, etc.) as described in greater detail below in reference to FIGS. 4-7. Example implementations include data retention and protection polices to ensure personally identifiable user data is scrubbed from any repositories. In cases where user data or a minimal amount of personally identifiable information is stored, the Analytics Model repositories 203 include data encryption and anonymization tools to restrict access or leakage of any sensitive information.

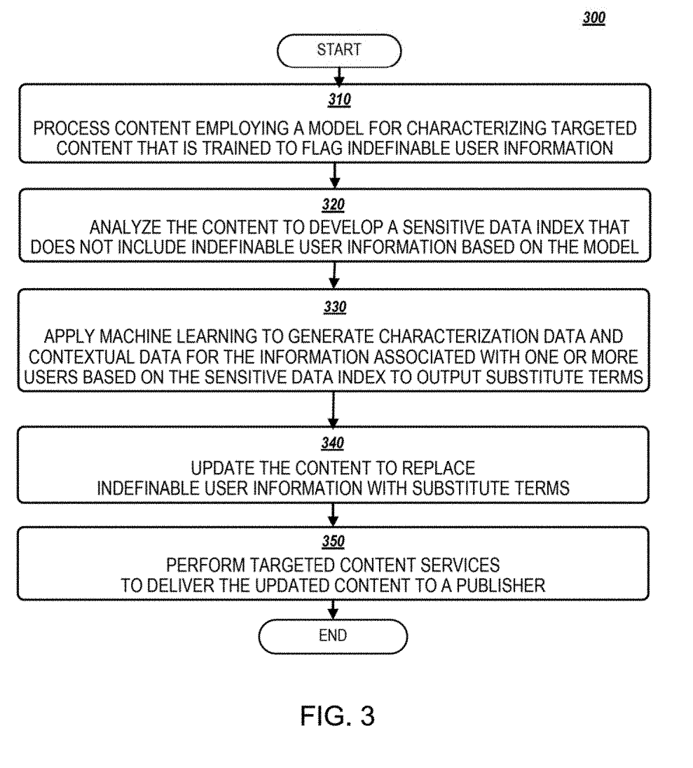

FIG. 3 illustrates a flow diagram of method 300 for a target protection service using an analytics model in accordance with an example implementation. The method 300 is performed by processing logic that may comprise hardware (circuitry, dedicated logic, etc.), software (such as operates on a general-purpose computer system or a dedicated machine), or a combination of both. Method 300 may be performed by the analytics platform 110 of FIG. 1 or Targeted Content Engine 210 of FIG. 2. Though method 300 is described herein as being performed by a runtime artificial intelligence system, method 300 may also be performed by other processing logic.

The target protection service 300 performs content analysis to enforce privacy practices during deployment. In an example implementation, the target protection service 300 receives new content on the fly that is analyzed. For each term identified that is not included in developed vocabularies, the target protection service 300 create a placeholder ID and construct the required analysis data for sensitive data based on its adjacent terms.

At 310, the processing device processes content employing a model for characterizing targeted content. The content can include information associated with one or more users, and the model is trained to flag indefinable user information. At 320, the processing device analyzes the content to develop a sensitive data index based on content that is flagged by the model. The sensitive data index is designed to not include indefinable user information that would otherwise create a security threat.

At 330. the processing device applies machine learning to generate characterization data and contextual data for the information associated with one or more users based on the sensitive data index. The machine learning utilizes content adjacent to the information associated with one or more users and the sensitive data index in a neural network to output substitute terms.

At 340, the processing device updates the content to replace indefinable user information with substitute terms. At 350, the processing device performs targeted content services to deliver the updated content to a publisher. For example, the processing device receives content associated with a user's digital activities in a source form, applies a conversion framework based on the source form that outputs the content as data in a development form, and the processing device determines contextual terms of the data in the development form.

FIG. 4 illustrates how the analytics technology converts data of any type to plain text (it may be good to refer the supported types). The analytics technology converts every kind of content to text and follows a unified analysis approach after that. In an example implementation, a data handling model 400 describes a custom framework for rapid content conversion which utilizes signal processing, image and video characterization, deep learning and machine learning. The data handling model 400 is modular and supports multiple design and development cycles for each component (e.g., one of the conversion frameworks can be replaced without modifying the other components).

According to an example implementation, the data handling model 400 takes in input, converts the input using one or more conversion algorithms, and outputs the conversion to enable targeted content based on the user generated content. In an example, the data handling model 400 is tailored to deliver content analysis and characterization in less than a 1 milliseconds for the given input.

Content input can be retrieved in various forms including text, speech, image, video, etc. For example, the content input is converted, if not text, to text as illustrated in FIG. 4. The conversion can include signal process framework, image to text characterization framework, video to text characterization framework, to name a few.

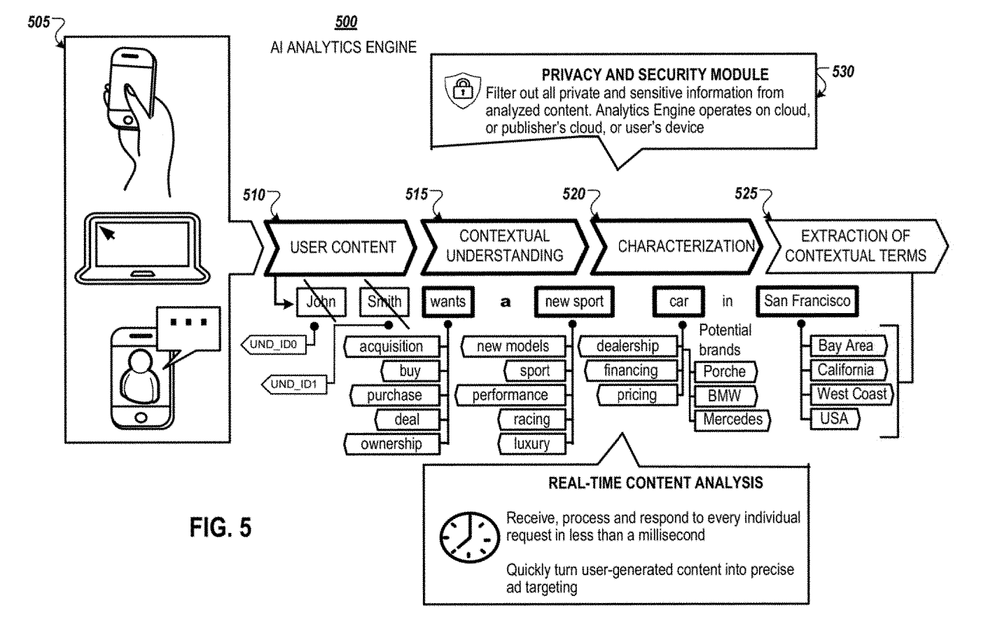

FIG. 5 illustrates an example analytics flow diagram 500 in accordance with an example implementation. The analytics flow diagram 500 can include retrieve user generated content that is processed by an analytics engine (e.g., real-time artificial intelligence system 230 of FIG. 2) to contextualize, characterize, and extract contextual terms as described herein.

The analytics flow diagram 500 includes a high-level presentation of the functionality of the analytics engine. The analytics engine retrieves the content from the user device (e.g., laptop, phone or voice assistant), filters out sensitive content and user information, performs contextual analyses and sentimental analyses. The analytics engine uses the results to characterize the content by using generic terms. In an example, the output of the analytics engine for the phrase “John Smith wants a new sport car in San Francisco” extracts context terms as shown.

For example, in response to receiving content with the phrase: “John Smith wants a new sports car in San Francisco,” the privacy and security module 215 of the analytics engine generates substitute terms that describe intention and interest. The processing by the analytics engine and the substitute terms do not expose any sensitive information about the ID of the person in the phrase (“John Smith”). For example, the process transforms the phrase “John Smith wants a new sport car in San Francisco” to “UND_ID0 UND_ID1 wants a new sport car in San Francisco”.

The analytics engine can anonymize user identifiers, for example, by removing names, to ensure privacy and legal compliance. The resulted contextual terms denote that somebody (e.g., the anonymized user) is looking to buy (acquisition, purchase, deal, ownership) a new sport (new models, sport, performance, racing, luxury) car (dealership, financing, pricing) with potential brands such as Porsche, BMW, Mercedes in San Francisco (Bay Area, Calif., West Coast, USA).

The analytics engine uses machine learning techniques and algorithms. Artificial intelligence driven technology is used to operate as a characterization and recommendation system for arbitrary content. According to an example implementation, characterization and recommendation system operates without prior knowledge about the content or its origin. The resulted recommendation is a set of generic descriptive terms or concepts (e.g., car, performance, luxury, etc.).

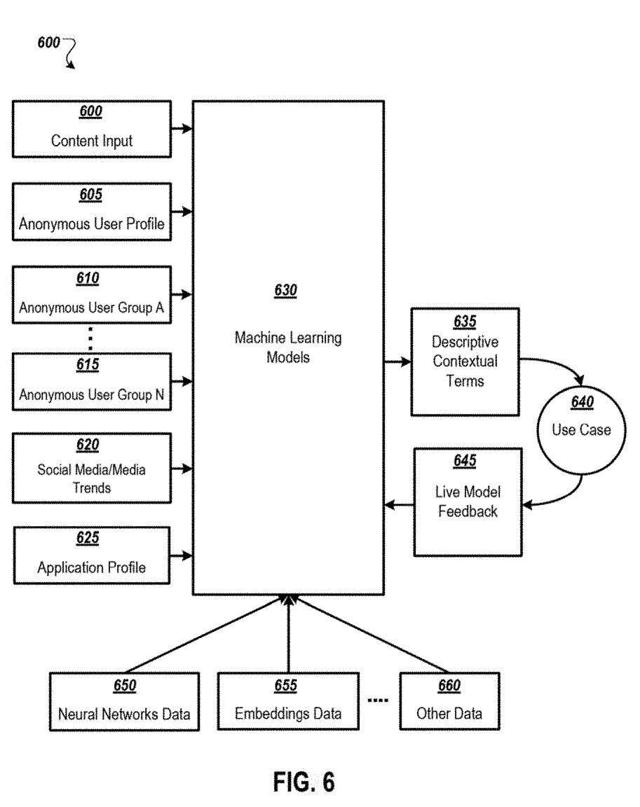

FIG. 6 illustrates an example analytics process 600 for an in accordance with an example implementation. FIG. 6 describes how the analytics technology receives as input the given content along with additional information. The analytics process 600 depicts functionality of the analytics engine. A set of machine learning models receive content (e.g., content provided by publishers). The first input can be content provided by a third party or user. Supplementary inputs are used which represent additional information about the user and the application content/environment. The supplementary inputs can include, but are not limited to:

a) Anonymous User Profile uses off-line Machine/Deep Learning to build user profiles which describe user interests and trends. For example, the analytics process 600 classifies users based on income, favorite activities, purchasing interests, etc. The generated profiles are anonymous and no personal information is preserved.

b) Anonymous User Groups A: user can belong to one or more groups. Each group can represent a population of users with shared traits and behavior patterns. For example, the anonymous user group can include all the Americans of the West Coast, USA that have high income and are interested in sport cars and racing. The user groups are generated with off-line Machine/Deep learning.

c) Social Media/Media Trends Our technology detects and extracts trends and patterns from popular social media (e.g., Facebook™, Twitter™, Pinterest™, etc.). The collected information is provided as input to the models.

d) Application Profile maintains and manages application specific profiles. These profiles describe the context of particular applications or use cases. These profiles are the result of off-line analysis and training.

The analytics engine supports diverse machine learning and deep learning techniques which can operate in isolation or in combination. According to an example embodiment, a graph-based API is provided to enable developers to describe computations associated with the models. The models may access to model data which can be, but not limited, matrices, vectors, etc. of neural networks or text embeddings.

Output of the models is a set of descriptive terms that characterize the content input. The output is provided as terms depending on the use case/application that utilizes the analytics engine. After the operation of the application, live feedback is optionally retrieved and used for real-time improvements of the models' accuracy and quality as part of a reinforcement learning procedure which performs continuously.

A key aspect of the disclosure provides a characterization and recommendation system that delivers high accuracy and extremely low-latency by utilizing an advanced data layout representations for the models' data and operation, optimization of the binary code that performs the model computations and efficient data communication as described in further detail below.

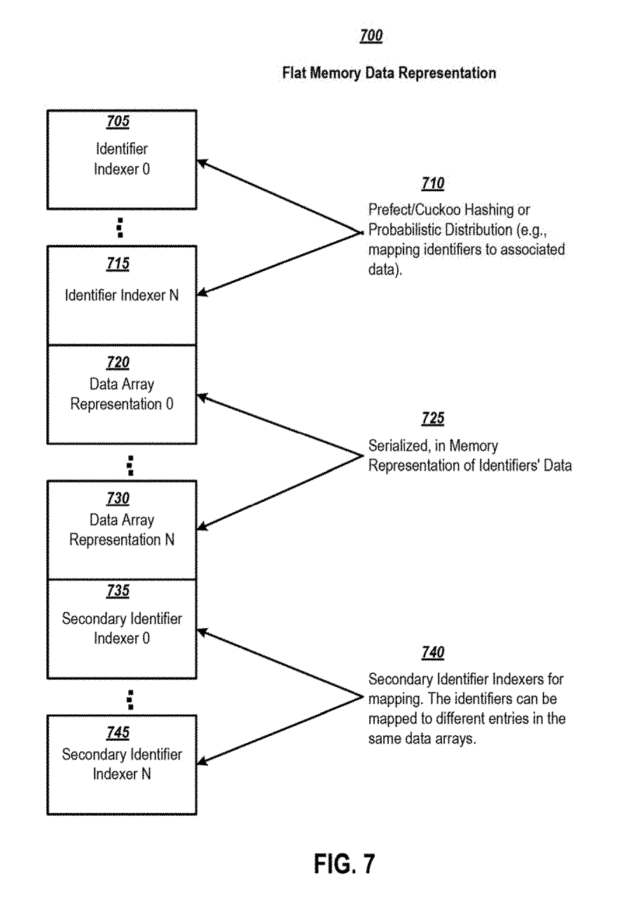

FIG. 7 illustrates an example data representation diagram 700 for an analytics engine in accordance with an example implementation. The data representation provides the necessary analysis and model data in low-latency and low-overhead manner. According to an embodiment, the analytics engine uses machine learning and analytics to access a tremendous amount of data that can be represented as a neural network. The neural network weights or embedding representations. Due to the nature of the content input and models, the engine rapidly serves irregular memory accesses. In order to achieve high memory access performance on commodity computer architectures a specialized data layout in memory is used.

As shown in FIG. 7a flat memory data representation places associated data in continuous memory locations. The design is built to include the following operations:

a) Rapid Mapping maps individual identifiers (e.g., words) to data entries. Each data entry may be a neural network, embedding vectors, a distribution of associated data or raw data used by one or more models. Multiple categories of identifiers and data are supported. For each category, an Identifier Indexer, data structure maps an identifier (e.g., word) to the entry of an associated Data Array Representation. The Data Array can include the actual data.

b) Secondary Rapping Mapping is used to index the identifiers and associated data in multiple, different ways to support the algorithm of the analytics engine. This is implemented by supporting Secondary Identifier Indexers, while using the same Data Array Representations. Functionality of the Identifier Indexers and Data Array Representations includes:

Identifier Indexer is responsible for mapping an identifier (e.g., word) to its associated data in a Data Array Representation. This delivers fast, fixed delay, mapping for thousands of identifiers. For example, the identifier indexer can use perfect hashing, cuckoo hashing, automata theory, finite state machines, etc. Micro-benchmarking and machine learning is used to identify the combination and parameters of the above techniques that deliver the highest performance on particular computer systems. According to an embodiment, the micro-benchmarking and machine learning procedure can be performed off-line.

Data Array Representation component preserves, in memory, the associated data of the identifiers. The data can have diverse forms, such as, but not limited to, neural network matrices, embedding vectors, word dictionaries. A flat memory representation is used for the data and an auto-tuner that performs optimal data placement for the particular computer design. The tuning procedure takes into account the cache hierarchy, the memory technology (e.g., frequency and channels), the type of processors that will access the data (e.g., CPU, GPU, specialized accelerators). The auto-tuner uses micro-benchmarks and decision trees and performs space exploration. According to an embodiment, the auto-tuner procedure can be performed off-line.

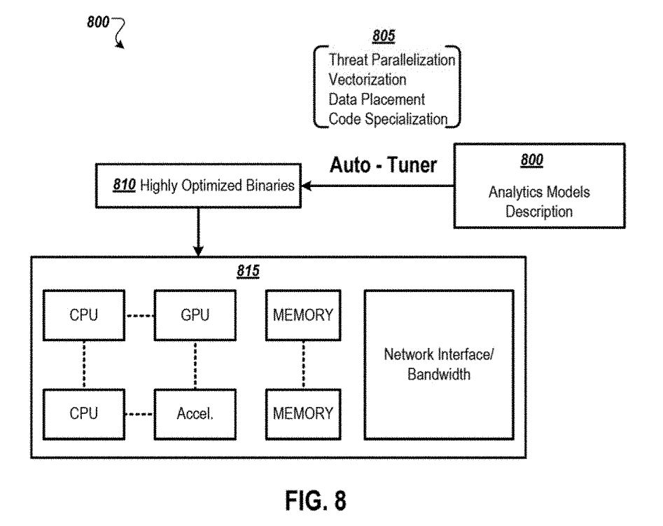

FIG. 8 depicts an example implementation for converting high level model descriptions to highly optimized code that delivers high performance on multi-core and heterogeneous platforms consisting of diverse processor, memory and networking technologies.

An example computing systems includes multi-core, heterogeneous processors, complex memory hierarchies and diverse network interfaces (e.g., infiniband, Ethernet, virtual interfaces). According to an example embodiment, the developer defines models in a high-level language by using abstractions such as graphs, operation pipelines, dataflow programming models, etc.

The auto-tuner transforms the high-level model representation provided by the developer to a high performance, program binary which takes advantage of the available computing and memory resources of the target system. The auto-tuner relies on compiler transformations and runtime libraries and enables the following program transformations seamlessly:

a) generate highly thread-parallel code which effectively utilizes the resources of multicores and accelerators such as CPUs.

b) vectorize our code to take advantage of the vector units found on CPUs and accelerators.

c) perform code specializations on real-time by leveraging static program analysis and runtime information about the data processed and operations performed.

d) perform data placement

e) use specialized scheduling policies for task processing that optimizes for high processor utilization, efficient memory accesses and efficient use of the network bandwidth. Scheduling techniques are aware of our strict requirements for low-latency.

The Analytics Engine described herein delivers both high accuracy and low-latencies rather than typical machine learning approaches that focus on training and deployment techniques that deliver the highest accuracy while high system performance and low-latencies are of low priority. However, in many cases depending the models and the nature of analytics, this is mutually exclusive. The Analytics Engine described herein is a system that mitigates that tradeoff. The input to the system is the required latency and acceptable accuracy levels. The model performs a space exploration for the models and provides the configuration that leads to the highest accuracy within the required latencies. Machine Learning techniques detect and eliminate low-performing configurations in advance and reduce the operation times for the space exploration.

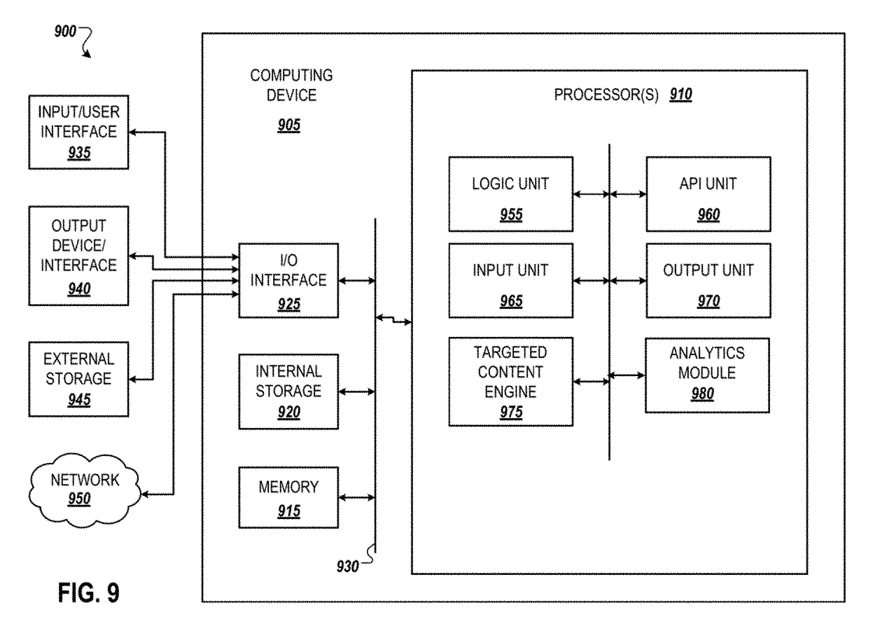

FIG. 9 shows an example computing environment with an example computing device associated with the external host for use in some example implementations. Computing device 905 in computing environment 900 can include one or more processing units, cores, or processors 910, memory 915 (e.g., RAM, ROM, and/or the like), internal storage 920 (e.g., magnetic, optical, solid state storage, and/or organic), and/or I/O interface 925, any of which can be coupled on a communication mechanism or bus 930 for communicating information or embedded in the computing device 905.

Computing device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touchscreen interface, keyboard, a pointing/cursor control, microphone, camera, braille, motion sensor, optical reader, and/or the like).

Output device/interface 940 may include a display, television, monitor, printer, speaker, braille, or the like. In some example implementations, input/user interface 935 and output device/interface 940 can be embedded with or physically coupled to the computing device 905. In other example implementations, other computing devices may function as or provide the functions of input/user interface 935 and output device/interface 940 for a computing device 905.

Examples of computing device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 905 can be communicatively coupled (e.g., via I/O interface 925) to external storage 945 and network 950 for communicating with any number of networked components, devices, and systems, including one or more computing devices of the same or different configuration. Computing device 905 or any connected computing device can be functioning as, providing services of, or referred to as a server, client, thin server, general machine, special-purpose machine, or another label.

The I/O interface 925 may include wireless communication components (not shown) that facilitate wireless communication over a voice and/or over a data network. The wireless communication components may include an antenna system with one or more antennae, a radio system, a baseband system, or any combination thereof. Radio frequency (RF) signals may be transmitted and received over the air by the antenna system under the management of the radio system.

I/O interface 925 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computing device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 955, application programming interface (API) unit 960, input unit 965, output unit 970, targeted content engine 975, and analytics module 980. For example, input unit 965, targeted content engine 975, and analytics module 980, may implement one or more processes shown in FIGS. 1-2. The described units and elements can be varied in design, function, configuration, or implementation and are not limited to the descriptions provided.

In some example implementations, the analytics module 980 operates on a client device such as 125a-125n of FIG. 1 In some example implementations, when information or an execution instruction is received by API unit 960, it may be communicated to one or more other units (e.g., logic unit 955, output unit 970, input unit 965, targeted content engine 975, and analytics module 980).

Input unit 965 may, via API unit 960, interact with the targeted content engine 975, and analytics module 980, to provide the input information. Using API unit 960, targeted content engine 975, and analytics module 980, the system can analyze the information to provide targeted content to publishes with characterized information, for example.

In some instances, logic unit 955 may be configured to control the information flow among the units and direct the services provided by API unit 960, input unit 965, output unit 970, input unit 965, targeted content engine 975, and analytics module 980, in some example implementations described above. For example, the flow of one or more processes or implementations may be controlled by logic unit 955 alone or in conjunction with API unit 960.

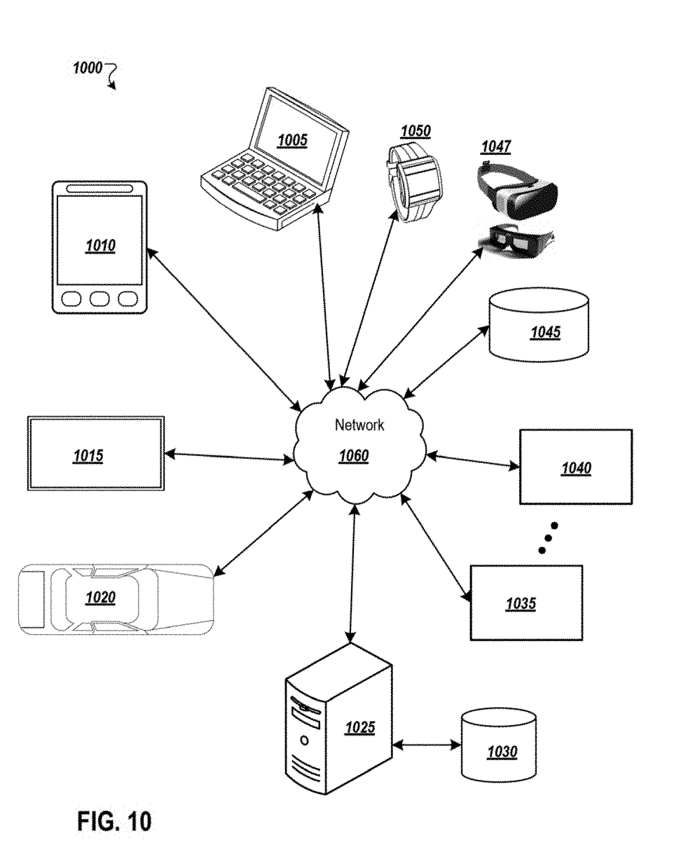

FIG. 10 shows an example environment suitable for some example implementations. Environment 1000 includes devices 1005-1050, and each is communicatively connected to at least one other device via, for example, network 1060 (e.g., by wired and/or wireless connections). Some devices may be communicatively connected to one or more storage devices 1030 and 1045.

An example of one or more devices 1005-1050 may be computing devices 905 described in regards to FIG. 9, respectively. Devices 1005-1050 may include, but are not limited to, a computer 1005 (e.g., a laptop computing device) having a display and as associated webcam as explained above, a mobile device 1010 (e.g., smartphone or tablet), a television 1015, a device associated with a vehicle 1020, a server computer 1025, computing devices 1035-1040, storage devices 1030 and 1045, augments reality and virtual reality devices 1047. As explained above, the meeting environment of the user may vary, and is not limited to an office environment.

In some implementations, devices 1005-1020, 1050 may be considered user devices associated with the users of the enterprise. Devices 1025-1050 may be devices associated with client service (e.g., used by the users or administrators to provide targeting services as described above and with respect to FIGS. 1-8, and/or store data, such as sensed data, pinpoint data, environment data, webpages, text, text portions, images, image portions, audios, audio segments, videos, video segments, and/or information thereabout).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as “receiving,” “applying” “determining,” “gathering,” “generating,” “processing,” “performing,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium.

A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method operations. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application.

Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

The example implementations may have various differences and advantages over related art. For example, but not by way of limitation, as opposed to instrumenting web pages with JavaScript as explained above with respect to the related art, text and mouse (e.g., pointing) actions may be detected and analyzed in video documents.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

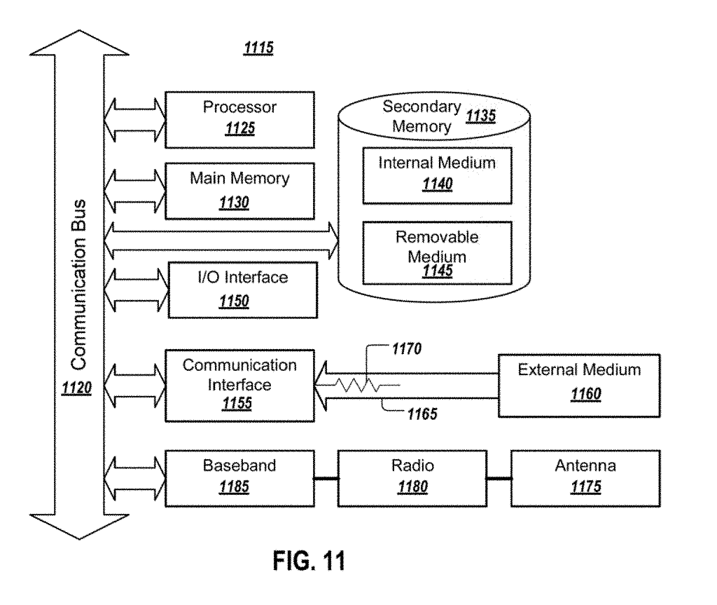

FIG. 11 provides a block diagram illustrating an example computing device or system that may be used in connection with various example implementations described herein. For example the system 1105 may be used as or in conjunction with one or more of the mechanisms or processes described above, and may represent components of processors, user system(s), and/or other devices described herein. The system 1105 can be a server or any conventional personal computer, or any other processor-enabled device that is capable of wired or wireless data communication. Other computer systems and/or architectures may be also used, as will be clear to those skilled in the art.

The system 1105 preferably includes one or more processors, such as processor 1115. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1115. Examples of processors which may be used with system 1105 include, without limitation, the Pentium® processor, Core i7® processor, and Xeon® processor, all of which are available from Intel Corporation of Santa Clara, Calif.

The processor 1115 is preferably connected to a communication bus 1110. The communication bus 1110 may include a data channel for facilitating information transfer between storage and other peripheral components of the system 1105. The communication bus 1110 further may provide a set of signals used for communication with the processor 1115, including a data bus, address bus, and control bus (not shown). The communication bus 1110 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 1188 general-purpose interface bus (GPIB), IEEE 696/S-30, and the like.

System 1105 preferably includes a main memory 1120 and may also include a secondary memory 1125. The main memory 1120 provides storage of instructions and data for programs executing on the processor 1115, such as one or more of the functions and/or modules discussed above. It should be understood that programs stored in the memory and executed by processor 1115 may be written and/or compiled according to any suitable language, including without limitation C/C++, Java, JavaScript, Pearl, Visual Basic, .NET, and the like. The main memory 1120 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 1125 may optionally include an internal memory 1130 and/or a removable medium 1135, for example a floppy disk drive, a magnetic tape drive, a compact disc (CD) drive, a digital versatile disc (DVD) drive, other optical drive, a flash memory drive, etc. The removable medium 1135 is read from and/or written to in a well-known manner. Removable storage medium 1135 may be, for example, a floppy disk, magnetic tape, CD, DVD, SD card, etc.

The removable storage medium 1135 is a non-transitory computer-readable medium having stored thereon computer executable code (i.e., software) and/or data. The computer software or data stored on the removable storage medium 1135 is read into the system 1105 for execution by the processor 1115.

In alternative example implementations, secondary memory 1125 may include other similar means for allowing computer programs or other data or instructions to be loaded into the system 1105. Such means may include, for example, an external storage medium 1150 and an interface 1145. Examples of external storage medium 1150 may include an external hard disk drive or an external optical drive, or and external magneto-optical drive.

Other examples of secondary memory 1125 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 1135 and communication interface 1145, which allow software and data to be transferred from an external medium 1150 to the system 1105.

System 1105 may include a communication interface 1145. The communication interface 1145 allows software and data to be transferred between system 1105 and external devices (e.g., printers), networks, or information sources. For example, computer software or executable code may be transferred to system 1105 from a network server via communication interface 1145. Examples of communication interface 1145 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 1105 with a network or another computing device.

Communication interface 1145 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 1145 are generally in the form of electrical communication signals 1160. These signals 1160 are preferably provided to communication interface 1145 via a communication channel 1155. In one example implementation, the communication channel 1155 may be a wired or wireless network, or any variety of other communication links. Communication channel 1155 carries signals 1160 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 1120 and/or the secondary memory 1125. Computer programs can also be received via communication interface 1145 and stored in the main memory 1120 and/or the secondary memory 1125. Such computer programs, when executed, enable the system 1105 to perform the various functions of the present invention as previously described.

In this description, the term “computer readable medium” is used to refer to any non-transitory computer readable storage media used to provide computer executable code (e.g., software and computer programs) to the system 1105. Examples of these media include main memory 1120, secondary memory 1125 (including internal memory 1130, removable medium 1135, and external storage medium 1150), and any peripheral device communicatively coupled with communication interface 1145 (including a network information server or other network device). These non-transitory computer readable mediums are means for providing executable code, programming instructions, and software to the system 1105.

In an example implementation that is implemented using software, the software may be stored on a computer readable medium and loaded into the system 1105 by way of removable medium 1135, I/O interface 1140, or communication interface 1145. In such an example implementation, the software is loaded into the system 1105 in the form of electrical communication signals 1160. The software, when executed by the processor 1115, preferably causes the processor 1115 to perform the inventive features and functions previously described herein.

In an example implementation, I/O interface 1140 provides an interface between one or more components of system 1105 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 1105 also includes optional wireless communication components that facilitate wireless communication over a voice and over a data network. The wireless communication components comprise an antenna system 1165, a radio system 1170, and a baseband system 1175. In the system 1105, radio frequency (RF) signals are transmitted and received over the air by the antenna system 1165 under the management of the radio system 1170.

In one example implementation, the antenna system 1165 may comprise one or more antennae and one or more multiplexors (not shown) that perform a switching function to provide the antenna system 1165 with transmit and receive signal paths. In the receive path, received RF signals can be coupled from a multiplexor to a low-noise amplifier (not shown) that amplifies the received RF signal and sends the amplified signal to the radio system 1170.

In alternative example implementations, the radio system 1170 may comprise one or more radios that are configured to communicate over various frequencies. In one example implementation, the radio system 1170 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 1170 to the baseband system 1175.

If the received signal contains audio information, then baseband system 1175 decodes the signal and converts it to an analog signal. Then the signal is amplified and sent to a speaker. The baseband system 1175 also receives analog audio signals from a microphone. These analog audio signals are converted to digital signals and encoded by the baseband system 1175. The baseband system 1175 also codes the digital signals for transmission and generates a baseband transmit audio signal that is routed to the modulator portion of the radio system 1170. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1165 where the signal is switched to the antenna port for transmission.

The baseband system 1175 is also communicatively coupled with the processor 1115. The central processing unit 1115 has access to data storage areas 1120 and 1125. The central processing unit 1115 is preferably configured to execute instructions (i.e., computer programs or software) that can be stored in the memory 1120 or the secondary memory 1125. Computer programs can also be received from the baseband processor 1165 and stored in the data storage area 1120 or in secondary memory 1125, or executed upon receipt. Such computer programs, when executed, enable the system 1105 to perform the various functions of the present invention as previously described. For example, data storage areas 1120 may include various software modules (not shown).

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system for data processing comprising:
a memory;
one or more processors coupled to the memory, wherein the processor is to:
process content employing a model for characterizing targeted content, wherein the content comprises information associated with one or more users, and wherein the model is trained to flag indefinable user information;
analyze the content to develop a sensitive data index based on content that is flagged by the model, wherein the sensitive data index does not include indefinable user information;
apply machine learning to generate characterization data and contextual data for the information associated with one or more users based on the sensitive data index, wherein the machine learning utilizes content adjacent to the information associated with one or more users and the sensitive data index in a neural network to output substitute terms;
update the content to replace indefinable user information with substitute terms; and
perform targeted content services to deliver the updated content to a publisher.

2. A method for data processing comprising:
processing content employing a model for characterizing targeted content, wherein the content comprises information associated with one or more users, and wherein the model is trained to flag indefinable user information;
analyzing the content to develop a sensitive data index based on content that is flagged by the model, wherein the sensitive data index does not include indefinable user information;
applying machine learning to generate characterization data and contextual data for the information associated with one or more users based on the sensitive data index, wherein the machine learning utilizes content adjacent to the information associated with one or more users and the sensitive data index in a neural network to output substitute terms;
updating the content to replace indefinable user information with substitute terms; and
performing targeted content services to deliver the updated content to a publisher.
